(19) United States
(12) Patent Application Publication
(10) Pub. No.: US 2026/0254618 A1
(43) Pub. Date: Aug. 27, 2026

(54) ENCRYPTION METHOD BASED ON HIGH-DIMENSIONAL INTERATIVE FUNCTIONS

(71) Applicant: Great Bay University, Dongguan (CN)

(72) Inventors: Fengxia LIU, Dongguan (CN); Yi ZHANG, Dongguan (CN); Kun TIAN, Dongguan (CN); Heng GUO, Dongguan (CN)

(21) Appl. No.: 19/649,235

(22) Filed: Apr. 16, 2026

(30) Foreign Application Priority Data
Jul. 30, 2025 (CN) 202511057363.3

(51) Int. Cl. H04L 9/08; H04L 9/06; H04L 9/30

(52) U.S. Cl. CPC H04L 9/0825; H04L 9/0618; H04L 9/3033

(57) ABSTRACT

The present disclosure discloses an encryption method based on high-dimensional iterative functions, belonging to the technical field of data encryption. The system comprises the following steps: s1: establishing calculation parameters, determining plaintext space p, ciphertext space C, and a private key sk through calculation parameters, s2: constructing an iterative function system, and obtaining a corresponding public key pk; s3: for plaintext w and ciphertext c, converting plaintext w to be encrypted into plaintext space C for encryption and decryption. The present disclosure adopts the method to construct an IFS different from previous forms, and constructing an encryption system based on a two-dimensional IFS. In addition, the present disclosure improves randomness in selecting encryption parameters, and due to the design of trapdoor functions, an existence of nonlinearity enhances a security of the encryption system.

### TECHNICAL FIELD

The present disclosure relates to a technical field of data encryption, particularly to an encryption method based on high-dimensional iterative functions.

### BACKGROUND

The public key cryptography systems based on mathematical iterative functions represent a new type of cryptographic that combines fractal theory, matrix operations, and other mathematical tools. The development background is closely related to addressing limitation of traditional public key cryptography and threat of quantum computing. The following is a comprehensive analysis of representative systems, development history, and application fields. However, there are some problems that need to be solved in the current forensic process, including complex key distribution process and high cost; exponential growth in key combinations during multi-party communications; during communication, mandatory key synchronization for secure information transmission; and security vulnerabilities such as signature forgery by recipients and message repudiation by senders; in terms of security, receiver can forge signatures, and sender can deny sending certain information. Therefore, it is necessary to provide a public key cryptosystem based on iterative function systems to solve the above problems.

### SUMMARY

The purpose of the present disclosure is to provide an encryption method based on high-dimensional iterative functions, proposing an iterative function in two-dimensional space, constructing trapdoors accordingly, and improving randomness of keys and public keys.

To achieve the above objectives, the present disclosure provides an encryption method based on high-dimensional iterative functions, including:
s1: establishing calculation parameters, determining a plaintext space P, ciphertext space C, and a private key sk through the calculation parameters;
s2: constructing an iterative function system and obtaining a corresponding public key pk;
s3: for plaintext w and ciphertext c, converting plaintext w to be encrypted into ciphertext space C for encryption and decryption.

In some embodiments, specific process of s1 includes:
randomly selecting positive integers n, t₁≥3, t₂≥3, a formula for obtaining plaintext space P is:

$$P = {\{ 0 , 1 \}}^{n} ;$$

where a plaintext space P is a string space of length n containing only 0 and 1;
randomly selecting integers a₁, b₁, a₂, b₂ that satisfy a formula:

$$0 \leq {a}_{1} < {b}_{1} \leq {t}_{1} - 1 ; 0 \leq {a}_{2} < {b}_{2} \leq {t}_{2} - 1 ;$$

randomly selecting positive integers δ₁, δ₂ that satisfy a formula:

$$1 \leq {δ}_{1} \leq min \{ {t}_{1} - {b}_{1} , {b}_{1} - {a}_{1} \} ; 1 \leq {δ}_{2} \leq min \{ {t}_{2} - {b}_{2} , {b}_{2} - {a}_{2} \} ;$$

randomly selecting prime number p, satisfying p>max{t₁, t₂}ⁿ⁺²; setting parameters through prime numbers:

$${ℤ}_{p} = \{ 0 , 1 , … , p - 1 \} , {ℤ}_{p}^{*} = \{ 1 , 2 , … , p - 1 \} ;$$

a formula for obtaining key space is:

$$C = {ℤ}_{p} \times {ℤ}_{p}^{*} = \{ 0 , 1 , … , p - 1 \} \times \{ 1 , 2 , … , p - 1 \} ;$$

randomly selecting a two-dimensional integer vector (x₀, y₀) from [symbol] ₚ× [symbol] ₚ*, randomly selecting two integers c₁ and c₂ from [symbol] ₚ*, setting a reversible function u(x, y)=(c₁xy, c₂y), setting calculation parameters β=u⁻¹(x₀, y₀)∈ [symbol] ₚ× [symbol] ₚ*, obtaining a private key sk as:

$$s k = \{ t = ( {t}_{1} , {t}_{2} , {a}_{1} , {a}_{2} , {b}_{1} , {b}_{2} , {δ}_{1} , {δ}_{2} ) , u ( x , y ) \} ;$$

where u(x, y) is a trapdoor function.

In some embodiments, specific process of s2 includes:
process of obtaining the public key pk is:
setting a binary function as:

$${f}_{0} ( x , y ) = ( \frac{{δ}_{1} x + {a}_{1}}{{t}_{1}} , \frac{{δ}_{2} y + {a}_{2}}{{t}_{2}} ) , {f}_{1} ( x , y ) = ( \frac{{δ}_{1} x + {b}_{1}}{{t}_{1}} , \frac{{δ}_{2} y + {b}_{2}}{{t}_{2}} ) ;$$

a formula for defining an iterative function system is:
for any plaintext w, w=w₁ w₂ . . . wₙ∈{0,1}ⁿ, define:

$${Φ}_{w} ( x , y ) = {f}_{w 1} ∘ {f}_{w 2} ∘ … ∘ {f}_{w n} ( x , y ) ;$$

where Φ_{w}(x, y) is an iterative function system, for positive integers m₁, m₂, k₁, k₂, defining Φ:

$$Φ ( \begin{matrix}\frac{{m}_{1}}{{k}_{1}} \\ {t}_{1}\end{matrix} , \begin{matrix}\frac{{m}_{2}}{{k}_{2}} \\ {t}_{2}\end{matrix} ) = ( {( {t}_{1}^{- 1} )}^{{k}_{1}} {m}_{1} , {( {t}_{2}^{- 1} )}^{{k}_{2}} {m}_{2} ) mod p ;$$

where Φ is expressed as a remainder of ((t₁⁻¹)^{k}^{₁}m₁, (t₂⁻¹)^{k}^{₂}m₂) divided by p, converting a fraction to integer;
setting a binary function:

$${f}_{0}^{*} ( x , y ) = Φ ∘ {f}_{0} ( x , y ) , {f}_{1}^{*} ( x , y ) = Φ ∘ {f}_{1} ( x , y ) ;$$

obtaining parameters:

$${g}_{0} ( x , y ) = {u}^{- 1} ∘ {f}_{0}^{*} ∘ u ( x , y ) , {g}_{1} ( x , y ) = {u}^{- 1} ∘ {f}_{1}^{*} ∘ u ( x , y ) ;$$

obtaining a public key pk:

$$p k = \{ p , {g}_{0} ( x , y ) , {g}_{1} ( x , y ) \} ;$$

where p represents a randomly selected prime number.

In some embodiments, specific process of encryption and decryption in s3 includes:
encryption process: for any plaintext w∈{0,1}ⁿ, calculating

$${F}_{w}^{*} ( x , y ) = {g}_{w 1} ∘ {g}_{w 2} ∘ … ∘ {g}_{w n} ( x , y ) ,$$

obtaining ciphertext c:

$$c = {F}_{w}^{*} ( β ) ∈ {ℤ}_{p} \times {ℤ}_{p}^{*} ;$$

where c is ciphertext;
decryption process: for any ciphertext c, calculating m=u(c)∈ [symbol] ₚ× [symbol] ₚ*, m=(m₁,m₂),
a calculation formula is expressed as:

$${α}_{1} = \frac{{t}_{1}^{n} {m}_{1} mod p}{{t}_{1}^{n}} , {α}_{2} = \frac{{t}_{2}^{n} {m}_{2} mod p}{{t}_{2}^{n}} , {α}_{1} , {α}_{2} ∈ ( 0 , 1 ) ;$$

where converting α₁ to a decimal in base t₁, α₁=(0. r₁ r₂ . . . rₙ . . . )ₜ_{₁}, converting α₂ to a decimal in base t₂, α₂=(0. s₁ s₂ . . . sₙ . . . )ₜ_{₂};
wᵢ=0, when a₁≤rᵢ≤δ₁+a₁−1, a₂≤sᵢ≤δ₂+a₂−1; wᵢ=1, when b₁≤rᵢ≤δ₁+b₁−1, b₂≤sᵢ≤δ₂+b₂−1,1≤i≤n.

The present disclosure adopts the encryption method based on high-dimensional iterative functions, which has the following advantages:

This invention introduces an innovative iteration function system distinct from conventional designs and establishes an encryption framework based on two-dimensional space. The proposed encryption process features enhanced randomness in computational parameter selection and incorporates trapdoor functions to create nonlinear encryption mechanisms, thereby significantly strengthening system security. These advancements enable the solution's application across critical data encryption fields including secure communications, data encryption, digital signatures, identity authentication, and quantum-resistant infrastructure systems. The technical solution of the present disclosure will be further described in detail through the accompanying drawings and embodiments.

### BRIEF DESCRIPTION OF THE DRAWINGS

FIG. 1 shows an encryption method based on high-dimensional iterative functions according to the present disclosure.

### DETAILED DESCRIPTION OF THE EMBODIMENTS

To better illustrate the objectives, technical solutions, and advantages of the embodiments of this invention, the following section provides a comprehensive description of the technical solutions with reference to the accompanying drawings. It should be noted that the described embodiments represent only a subset of possible implementations rather than exhaustive examples. The components depicted in the drawings may be configured and designed in various configurations. Specific model specifications should be determined based on the actual dimensions of the device, with detailed selection calculations employing existing industry technologies, which will not be elaborated here.

### Embodiment

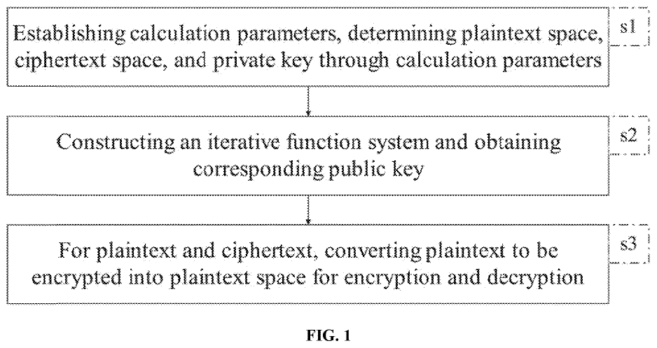

As shown in FIG. 1, the present disclosure provides an encryption method based on high-dimensional iterative functions, which now uses actual data for encryption and decryption calculations, including the following steps:
s1: establishing calculation parameters, determining a plaintext space P, ciphertext space C, and a private key sk through the calculation parameters; where specific process includes:
randomly selecting positive integers n=1, t₁=3, t₂=3, a formula for obtaining plaintext space P is:

$$P = {\{ 0 , 1 \}}^{n} ;$$

where a plaintext space P is a string space of length n containing only 0 and 1;
randomly selecting integers a₁=0, b₁=1, a₂=1, b₂=2 that satisfy a formula:

$$0 \leq {a}_{1} < {b}_{1} \leq {t}_{1} - 1 ; 0 \leq {a}_{2} < {b}_{2} \leq {t}_{2} - 1 ;$$

randomly selecting prime number p=29, satisfying a formula p>max{t₁, t₂}ⁿ⁺²; setting parameters through prime numbers:

$${ℤ}_{p} = \{ 0 , 1 , … , p - 1 \} , {ℤ}_{p}^{*} = \{ 1 , 2 , … , p - 1 \} ;$$

a formula for obtaining key space is:

$$C = {ℤ}_{p} \times {ℤ}_{p}^{*} = \{ 0 , 1 , … , p - 1 \} \times \{ 1 , 2 , … , p - 1 \} ;$$

randomly selecting a two-dimensional integer vector (x₀, y₀)=(3,3) from [symbol] ₚ× [symbol] ₚ*, randomly selecting two integers c₁=1 and c₂=1 from [symbol] ₚ*, setting a reversible function u(x, y)=(xy, y), setting calculation parameters β=u⁻¹(x₀, y₀)=(1,3), obtaining a private key sk as:

$$s k = \{ t = ( {t}_{1} , {t}_{2} , {a}_{1} , {a}_{2} , {b}_{1} , {b}_{2} , {δ}_{1} , {δ}_{2} ) , u ( x , y ) \} ;$$

where u(x, y) is set as a trapdoor function.
s2: constructing an iterative function system and obtaining a corresponding public key pk;
the process of obtaining the public key pk is:
setting a binary function:

$${f}_{0} ( x , y ) = ( \frac{{δ}_{1} x + {a}_{1}}{{c}_{1}} , \frac{{δ}_{2} y + {a}_{2}}{{c}_{2}} ) , {f}_{1} ( x , y ) = ( \frac{{δ}_{1} x + {b}_{1}}{{c}_{1}} , \frac{{δ}_{2} y + {b}_{2}}{{c}_{2}} ) ;$$

a formula for defining an iterative function system is:
for any plaintext w, w=w₁ w₂ . . . wₙ∈{0,1}ⁿ, a definition formula is:

$${Φ}_{w} ( x , y ) = {f}_{w 1} ∘ {f}_{w 2} ∘ … ∘ {f}_{w n} ( x , y ) ;$$

where Φ_{w}(x, y) is an iterative function system, for positive integers m₁, m₂, k₁, k₂, setting a function Φ as:

$$Φ ( \frac{{m}_{1}}{{t}_{1}^{{k}_{1}}} , \frac{{m}_{2}}{{t}_{2}^{{k}_{2}}} ) = ( {( {t}_{1}^{- 1} )}^{{k}_{1}} {m}_{1} , {( {t}_{2}^{- 1} )}^{{k}_{2}} {m}_{2} ) mod p ;$$

where Φ is expressed as a remainder of ((t₁⁻¹)^{k}^{₁}m₁, (t₂⁻¹)^{k}^{₂}m₂) divided by p, converting a fraction to integer;
defining a binary function:

$${f}_{0}^{*} ( x , y ) = Φ ∘ {f}_{0} ( x , y ) = Φ ( \frac{x}{3} , \frac{y + 1}{3} ) ,$$

$${f}_{1}^{*} ( x , y ) = Φ ∘ {f}_{1} ( x , y ) = Φ ( \frac{x + 1}{3} , \frac{y + 2}{3} ) ;$$

obtaining parameters:

$${g}_{0} ( x , y ) = {u}^{- 1} ∘ {f}_{0}^{*} ∘ u ( x , y ) , {g}_{1} ( x , y ) = {u}^{- 1} ∘ {f}_{1}^{*} ∘ u ( x , y ) ;$$

obtaining a public key pk:

$$p k = \{ p , {g}_{0} ( x , y ) , {g}_{1} ( x , y ) \} ;$$

where p represents a randomly selected prime number.
s3: for plaintext w and ciphertext c, converting plaintext w to be encrypted into plaintext space C for encryption and decryption, specific process of encryption and decryption includes:
encryption process: for any plaintext w=0∈{0,1}¹,

$${F}_{w}^{*} ( x , y ) = {g}_{w 1} ( x , y ) = {g}_{0} ( x , y ) = {u}^{- 1} ∘ {f}_{0}^{*} ∘ u ( x , y ) ,$$

obtaining ciphertext c:

$$c = {F}_{w}^{*} ( β ) = {u}^{- 1} ∘ {f}_{0}^{*} ∘ u ∘ {u}^{- 1} ( {x}_{0} , {y}_{0} ) = {u}^{- 1} ∘ {f}_{0}^{*} ( {x}_{0} , {y}_{0} ) ;$$

a calculated result is:

$${3}^{- 1} = 10 mod 29 ;$$

$${f}_{0}^{*} ( {x}_{0} , {y}_{0} ) = Φ ∘ {f}_{0} ( {x}_{0} , {y}_{0} ) = Φ ( \frac{{x}_{0}}{3} , \frac{{y}_{0} + 1}{3} ) = Φ ( 1 , \frac{4}{3} ) = ( 1 , 10 \times 4 ) = ( 1 , 11 ) mod 29 ;$$

a final ciphertext result is:

$$c = {u}^{- 1} ∘ {f}_{0}^{*} ( {x}_{0} , {y}_{0} ) = {u}^{- 1} ( 1 , 11 ) = ( 8 , 11 ) mod 29 ;$$

decryption process: for ciphertext c=(8,11), calculating m=(m₁, m₂)=u(c)=(1,11), m=(m₁,m₂), then m₁=1, m₂=11, the calculated result is:

$${α}_{1} = \frac{{t}_{1}^{n} \times {m}_{1} mod p}{{t}_{1}^{n}} = \frac{3 \times 1 mod 29}{3} = 1 ;$$

$${α}_{2} = \frac{{t}_{2}^{n} \times {m}_{2} mod p}{{t}_{2}^{n}} = \frac{3 \times 11 mod 29}{3} = \frac{4}{3} ;$$

converting α₁ to a decimal number in base 3, α1=(1.0)₃, converting α₂ to a decimal number in base 3, α₂=(1.1)₃, therefore r₁=0, s₁=1, satisfying a₁≤r₁≤δ₁+a₁−1, a₂≤s₁≤δ₂+a₂−1, so w=w₁=0.

Therefore, this present disclosure employs an encryption method based on high-dimensional iterative functions, constructing an innovative iterative function system distinct from conventional approaches and establishing an encryption framework within a two-dimensional space. Furthermore, the encryption process in this application enhances randomness during computational parameter selection and incorporates trapdoor functions to introduce nonlinearity, thereby significantly strengthening system security.

Finally, it should be noted that the aforementioned embodiments are provided solely to illustrate the technical solution of the present invention without limiting its scope. Although the present disclosure has been described in detail with reference to preferred embodiments, those skilled in the art should understand that modifications or equivalent substitutions may still be made to the technical solution without departing from the spirit and scope of the present disclosure.

What is claimed is:

1. An encryption system based on high-dimensional iterative functions, characterized by the following steps:
s1: establishing calculation parameters, determining a plaintext space P, ciphertext space C, and a private key sk through the calculation parameters;
s2: constructing an iterative function system and obtaining a corresponding public key pk;
s3: for plaintext w and ciphertext c, converting plaintext w to be encrypted into ciphertext space C for encryption and decryption.

2. The encryption method based on high-dimensional iterative functions according to claim 1, wherein specific process of s1 comprises:
randomly selecting positive integers n, t₁≥₃, t₂≥3, then obtain plaintext space P:
$$P = {\{ 0 , 1 \}}^{n} ;$$
where a plaintext space P is a string space of length n containing only 0 and 1;
randomly selecting integers a₁, b₁, a₂, b₂ that satisfying:
$$0 \leq {a}_{1} < {b}_{1} \leq {t}_{1} - 1 ; 0 \leq {a}_{2} < {b}_{2} \leq {t}_{2} - 1 ;$$
randomly selecting positive integers δ₁, δ₂ that satisfying:
$$1 \leq {δ}_{1} \leq min \{ {t}_{1} - {b}_{1} , {b}_{1} - {a}_{1} \} ; 1 \leq {δ}_{2} \leq min \{ {t}_{2} - {b}_{2} , {b}_{2} - {a}_{2} \} ;$$
randomly selecting prime number p, satisfying a formula p>max{t₁, t₂}ⁿ⁺²; setting parameters through prime numbers:
$${ℤ}_{p} = \{ 0 , 1 , … , p - 1 \} , {ℤ}_{p}^{*} = \{ 1 , 2 , … , p - 1 \} ;$$
the key space is:
$$C = {ℤ}_{p} \times {ℤ}_{p}^{*} = \{ 0 , 1 , … , p - 1 \} \times \{ 1 , 2 , … , p - 1 \}$$
randomly selecting a two-dimensional integer vector (x₀, y₀) from [symbol] ₚ× [symbol] ₚ*, randomly selecting two integers c₁ and c₂ from [symbol] ₚ*, setting a reversible function u(x, y)=(c₁xy, c₂y), setting calculation parameters β=u⁻¹(x₀, y₀)∈ [symbol] ₚ× [symbol] ₚ*, obtaining a private key sk as:
$$sk = \{ t = ( {t}_{1} , {t}_{2} , {a}_{1} , {a}_{2} , {b}_{1} , {b}_{2} , {δ}_{1} , {δ}_{2} ) , u ( x , y ) \} ;$$
wherein u(x, y) is a trapdoor function.

3. The encryption method based on high-dimensional iterative functions according to claim 1, wherein specific process of s2 comprises:
the process of obtaining the public key pk is:
setting a binary function as follows:
$${f}_{0} ( x , y ) = ( \frac{{δ}_{1} x + {a}_{1}}{{t}_{1}} , \frac{{δ}_{2} y + {a}_{2}}{{t}_{2}} ) , {f}_{1} ( x , y ) = ( \frac{{δ}_{1} x + {b}_{1}}{{t}_{1}} , \frac{{δ}_{2} y + {b}_{2}}{{t}_{2}} ) ;$$
defining an iterative function:
for any plaintext w, w=w₁ w₂ . . . wₙ∈{0,1}ⁿ, defining:
$${Φ}_{w} ( x , y ) = {f}_{w 1} ∘ {f}_{w 2} ∘ … ∘ {f}_{wn} ( x , y ) ;$$
wherein Φ_{w}(x, y) is an iterative function system, for positive integers m₁, m₂, k₁, k₂, defining Φ:
$$Φ ( \frac{{m}_{1}}{{t}_{1}^{{k}_{1}}} , \frac{{m}_{2}}{{t}_{2}^{{k}_{2}}} ) = ( {( {t}_{1}^{- 1} )}^{{k}_{1}} {m}_{1} , {( {t}_{2}^{- 1} )}^{{k}_{2}} {m}_{2} ) mod p ;$$
wherein Φ is expressed as a remainder of ((t₁⁻¹)^{k}^{₁}m₁, (t₂⁻¹)^{k}^{₂}m₂) divided by p, converting a fraction to integer;
setting a binary function as:
$${f}_{0}^{*} ( x , y ) = Φ ∘ {f}_{0} ( x , y ) , {f}_{1}^{*} ( x , y ) = Φ ∘ {f}_{1} ( x , y ) ;$$
obtaining parameters:
$${g}_{0} ( x , y ) = {u}^{- 1} ∘ {f}_{0}^{*} ∘ u ( x , y ) , {g}_{1} ( x , y ) = {u}^{- 1} ∘ {f}_{1}^{*} ∘ u ( x , y ) ;$$
and a public key pk:
$$pk = \{ p , {g}_{0} ( x , y ) , {g}_{1} ( x , y ) \} ;$$
wherein p represents a randomly selected prime number.

4. The encryption method based on high-dimensional iterative functions according to claim 1, wherein specific process of encryption and decryption in s3 comprises:
encryption process: for any plaintext w∈{0,1}ⁿ, calculating
$${F}_{w}^{*} ( x , y ) = {g}_{w 1} ∘ {g}_{w 2} ∘ … ∘ {g}_{wn} ( x , y ) ,$$
obtaining ciphertext c as:
$$c = {F}_{w}^{*} ( β ) ∈ {ℤ}_{p} \times {ℤ}_{p}^{*} ;$$
wherein c is ciphertext;
decryption process: for any ciphertext c, calculating m=u(c)∈ [symbol] ₚ× [symbol] ₚ*, m=(m₁,m₂),
the result is expressed as:
$${α}_{1} = \frac{{C}_{1}^{n} {m}_{1} mod p}{{t}_{1}^{n}} , {α}_{2} = \frac{{t}_{2}^{n} {m}_{2} mod p}{{t}_{2}^{n}} , {α}_{1} , {α}_{2} ∈ ( 0 , 1 ) ;$$
wherein writing α₁ as a decimal based on t₁, α₁=(0. r₁ r₂ . . . rₙ . . . )ₜ_{₁}, writing α₂ as a decimal based on t₂, α₂=(0. s₁ s₂ . . . sₙ . . . )ₜ_{₂};
wᵢ=0 when a₁≤rᵢ≤δ₁+a₁−1, a₂≤sᵢ≤δ₂+a₂−1; wᵢ=1 when b₁≤rᵢ≤δ₁+b₁−1, b₂≤sᵢ≤δ₂+b₂−1, 1≤i≤n.
